(19) United States
(12) Patent Application Publication
(10) Pub. No.: US 2008/0005344 A1
(43) Pub. Date: Jan. 3, 2008

(54) Method and system for configuring a network device using a template

(76) Inventors: Daniel E. Ford, Granite Bay, CA (US); Scott A. Gulland, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/478,571

(22) Filed: Jun. 29, 2006

(51) Int. Cl. G06F 15/16

(52) U.S. Cl. 709/230

(57) ABSTRACT

A network device is configured by a network manager. The network manager creates a pool identifier and a corresponding pool of network addresses. The network manager also creates a template identifier and a corresponding template including at least one reference to the pool identifier. A device identifier of the network device is set to the template identifier before coupling the network device to a network. The network manager discovers the network device on the network and obtains the device identifier via the network. The network device is configured by the network manager with a configuration that is the corresponding template for the template identifier having each reference to the pool identifier replaced with a network address from the corresponding pool for the pool identifier.

### FIELD OF THE INVENTION

The present disclosure generally relates to configuring a network device by a network manager.

### BACKGROUND

A communication network may interconnect a variety of computers, network switches and routers, and other network devices within an organization using an intranet and around the world using the internet. Generally, each network device on a network has a device configuration that may customize the operation of the network device, for example, each network device may have a globally unique network address according to the Internet Protocol version 6. The configuration for a network device may also include a particular combination of software packages that are tested to verify interoperability.

Because a network may interconnect a large number of network devices, the management of the device configurations for these network devices may be time-consuming and expensive. A network administrator may be a staff member with the responsibility of managing the device configurations of the network devices for a particular business or other organization. Often, the network devices managed by a network administrator may be geographically distributed, and the network administrator may need to travel to remote locations to manage the device configurations of the network devices at each remote location. Alternatively, the network administration may share the responsibility of managing device configuration of the network devices at a remote location with a support technician located at the remote location. However, sharing responsibility with the support technician may require sharing sensitive security data and require close cooperation between the network administrator and the support technician despite possibly non-overlapping work schedules, leading to various potential problems, such as compromising network security and failing to properly track each network device that is connected to the network.

The configuration of a network device may be complex and prone to error. Manual editing of a complex device configuration file and/or manual entering of a sequence of commands to a command language interpreter may be required to configure a network device. The manual operations may introduce various errors, such as a duplicated assignment of a network address to more than one network device. While a network administrator may require that large groups of network devices have similar device configurations, the manual operations needed to configure each network device may accidentally introduce unintentional variations for some device configurations. A process is needed that ensures the prompt and correct configuration of network devices.

### SUMMARY

Various embodiments of the invention provide a processor-implemented method for configuring a network device by a network manager. A pool identifier is created along with a corresponding pool of at least one network address using the network manager. A template identifier is created along with a corresponding template including at least one reference to the pool identifier using the network manager. A device identifier of the network device is set to a value including the template identifier before coupling the network device to a network. The network manager discovers the presence of the network device on the network and the device identifier is transferred from the network device to the network manager via the network. The network device is configured by the network manager via the network with a configuration that is the corresponding template for the template identifier having each reference to the pool identifier replaced with an unassigned network address from the corresponding pool for the pool identifier.

Various other embodiments of the invention provide a processor-implemented system for configuring a network device that is coupled to a network manager by a network. The network device has a device identifier that is initialized to a value including a template identifier. The network manager creates a pool identifier and a corresponding pool including at least one network address, and a template identifier and a corresponding template including at least one reference to the pool identifier. The network manager discovers the presence of the network device on the network, including obtaining the device identifier from the network device via the network. In response to the device identifier from the network device appropriately including the template identifier, the network manager configures the network device via the network with a configuration that is the corresponding template for the template identifier having each reference to the pool identifier replaced with an unassigned network address from the corresponding pool for the pool identifier.

It will be appreciated that various other embodiments are set forth in the Detailed Description and Claims which follow.

### BRIEF DESCRIPTION OF THE DRAWINGS

FIG. 1 is a block diagram of a system for configuring a network device by a network manager in accordance with various embodiments of the invention.

FIG. 2 is a flow diagram of a process for configuring a network device by a network manager in accordance with various embodiments of the invention.

FIG. 3 is a flow diagram of a process for preparing network devices for configuration in accordance with various embodiments of invention.

FIG. 4 is a flow diagram of a process for a network manager configuring network devices in accordance with various embodiments of the invention.

FIG. 5 is a flow diagram of a process for reconfiguring a network device in accordance with various embodiments of the invention.

FIG. 6 is a block diagram illustrating a program storage medium for configuring a network device in accordance with various embodiments of the invention.

### DETAILED DESCRIPTION

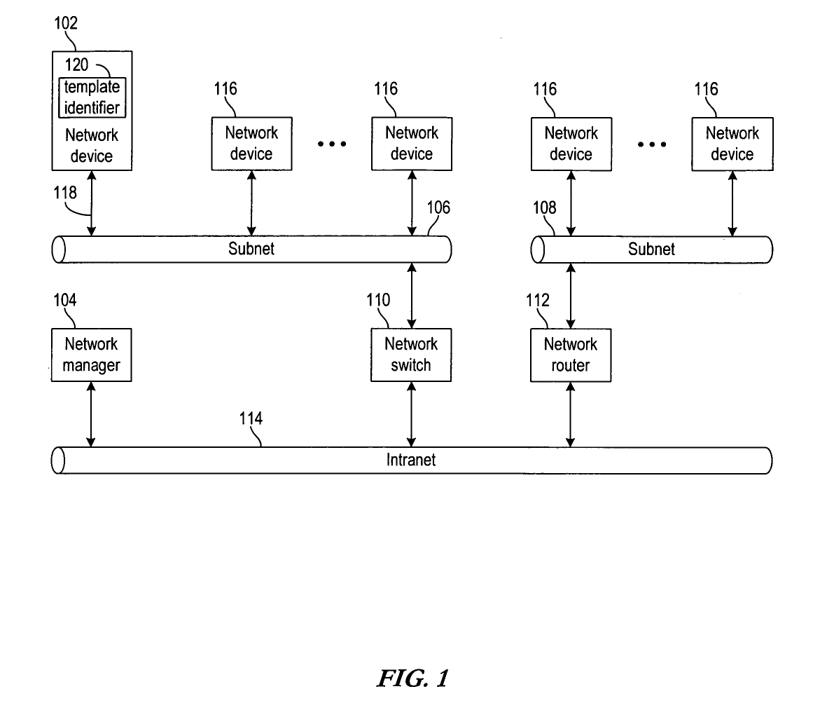

FIG. 1 is a block diagram of a system for configuring a network device 102 by a network manager 104 in accordance with various embodiments of the invention. The network may include various subnets 106 and 108 connected by network switches and/or routers 110 and 112 to other network segments, such as a local intranet 114. A network switch 110 and a network router 112 provide similar functions, with network switch 110 providing low-level forwarding of certain data packets between intranet 114 and subnet 106 generally using similar communication protocols, while network router 112 includes higher-level functions, such as packet segmentation and assembly, for forwarding certain data packets between subnet 108 and intranet 114 possibly using differing communication protocols.

The network devices of FIG. 1 may include network devices 102 and 116, and also may include network switch 110 and network router 112. Certain embodiments of the invention are used to configure network switch 110 and/or network router 112. The network manager 104 may be used to configure some or all of network devices 102 and 116, and network switch 110 and network router 112 via the network including subnet 106, subnet 108, and/or intranet 114. For example, the network manager 104 may be used to configure network device 102.

Before network device 102 is initially connected to the network via connection 118, a technician may set a device identifier 120 to a template identifier. The template identifier provided by the technician may determine the configuration that the network manager 104 uses to configure the network device 102. After setting the device identifier 120 to the template identifier, the technician may connect the network device 102 to the network using connection 118. The network manager 104 may discover the presence of the network device 102 on the network by periodic polling for new network devices and/or by the network device 102 announcing its presence on the network. Upon discovering the presence of the network device 102 on the network, the network manager 104 may query the value of the device identifier 120. Because the value of the device identifier 120 is a template identifier, the network manager 104 generates a configuration from a template corresponding to the template identifier, and the network manager 104 transfers this generated configuration to the network device 102 to configure the network device 102.

The configuration of the network device 102 by the network manager 104 may include updating the value of the device identifier 120 to another value. The device identifier 120 may be provided by the network device 102 for purposes including identifying a person or contact that is responsible for the network device 102, and the generated configuration used by the network manager 104 to configure the network device 102 may include updating the device identifier 120 to a name of the person or contact that is responsible for the network device 102. By changing the value of the device identifier 120, reconfiguration of the network device 102 may be skipped when the network device 102 is rediscovered, for example, after a power cycling and reboot of the network device 102. Alternatively, the device identifier 120 may be updated with another value that still includes the template identifier, but also includes a revision number for the corresponding template, such that the network device 102 is reconfigured upon rediscovery by the network manager 104 when the revision number from the device identifier 120 does not match the current revision of the corresponding template.

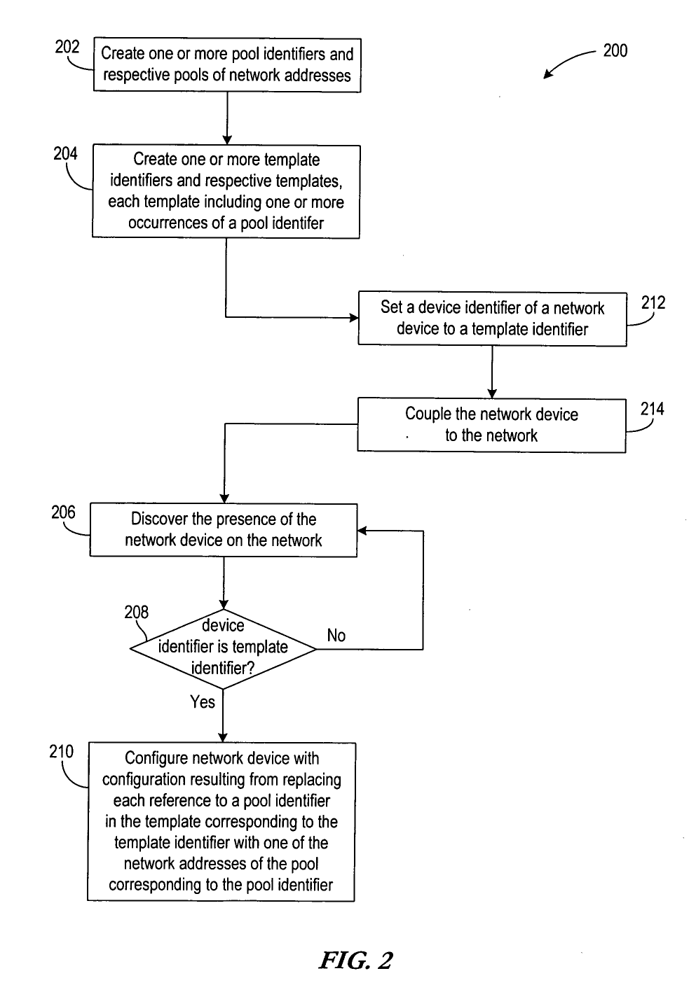

FIG. 2 is a flow diagram of a process 200 for configuring a network device by a network manager in accordance with various embodiments of the invention. Steps 202 through 210 may be performed by the network manager and steps 212 and 214 may be performed by a technician at the location of the network device. The network manager and the network device are connected by a network, but they may be in different locations, such as different buildings or even in different countries.

At step 202, one or more pool identifiers and corresponding pools of network addresses are created. Each pool identifier identifies a corresponding pool, which includes one or more network addresses that are initially unassigned to any network device. At step 204, one or more template identifiers and corresponding templates are created. Each template identifier identifies a corresponding template, which may be similar to a device configuration file for a network device, except that each occurrence of a network address for the network device is replaced by a reference to a pool identifier. During configuration of the network device, a device configuration file for the network device may be generated from the template by substituting the references to the pool identifier with one of the network addresses from the corresponding pool.

At step 212, a technician may set the device identifier to a value that includes one of the template identifiers. In one embodiment, the device identifier is set to a value similar to a tag in an extensible markup language. For example, the device identifier of a network device configured by the ProCurve Manager available from Hewlett-Packard Company may be set to the value <PCM_Template=templateidentifier> with templateidentifier being the text string for the specified template identifier. A network device that is not yet configured may permit the device identifier to be changed by a technician without any special security permissions. At step 214, the technician couples the network device to the network.

At step 206, the network manager, such as the ProCurve Manager software executing on a desktop computer, discovers the presence of the network device on the network. The network manager obtains the device identifier from the discovered network device via the network. Decision 208 may check whether the device identifier includes a template identifier in the appropriate format and whether such a template identifier matches a template identifier and corresponding template created at step 204, and for a match process 200 proceeds to step 210.

At step 210, a configuration, such as a device configuration file, is created from the corresponding template for the template identifier. The configuration may be created by replacing the references to a pool identifier in the corresponding template with one of the network addresses from the corresponding pool created at step 202. Generally, a network address that is not already assigned to another network device is selected from the corresponding pool. The configuration may specify all of the configurable parameters for the network device, including the network address used by the network device to send and receive data packets over the network. By configuring the network device with a configuration generated from a template, the network device may be promptly and correctly configured with a configuration that matches any other network devices that already are configured using the configuration, with the exception that each of these network devices may be configured with a unique network address from the corresponding pool of the pool identifier referenced by the template.

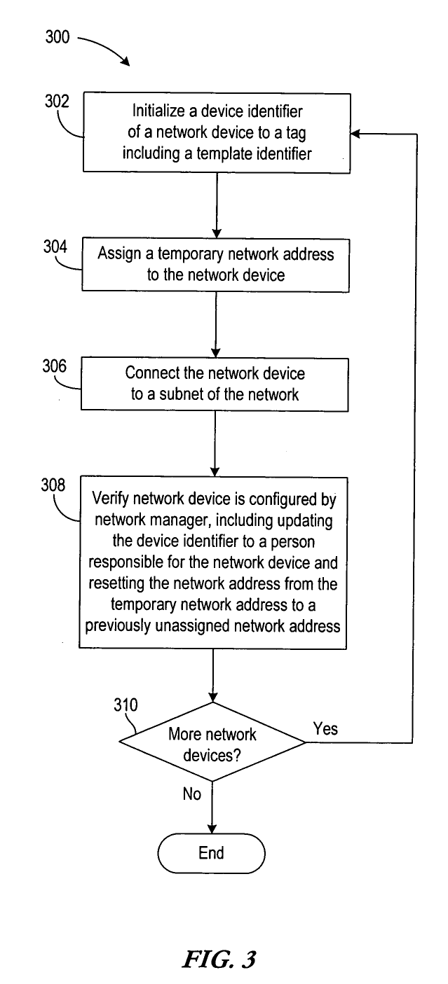

FIG. 3 is a flow diagram of a process 300 for preparing network devices for configuration in accordance with various embodiments of invention. A technician or other personnel at the location for the network devices may perform process 300.

At step 302, a device identifier of the network device is initialized to a tag that includes a template identifier. The template identifier may be non-sensitive data that is selected by a network administrator and communicated to the technician. At step 304, a temporary network address is assigned to the network device. In one embodiment, the temporary network address is included in a default configuration for the network device and step 304 may be skipped. At step 306, the technician connects the network device to a subnet of the network.

After connecting the network device to the subnet, the network device should be discovered and configured by the network manager. At step 308, the technician may verify that the network device has been discovered and configured by the network manager. In certain embodiments, this may include verifying that the device identifier is updated to a name of a person responsible for the network device and that the network address for the network device is updated from the temporary network address to a previously unassigned network address.

Decision 310 checks whether any more network devices need to be configured to become part of the network, and for more network devices needing configuration, process 300 returns to step 302 for the next network device. Usually, each of the network devices configured during process 300 is permanently assigned a unique network address. However, in certain scenarios, such as a major reconfiguration of the structure of a network, process 300 may be repeated to assign a different network address to some or all of the network devices. A network administrator or other personnel with access to sensitive security information may need to enable the network devices for configuration with a different network address.

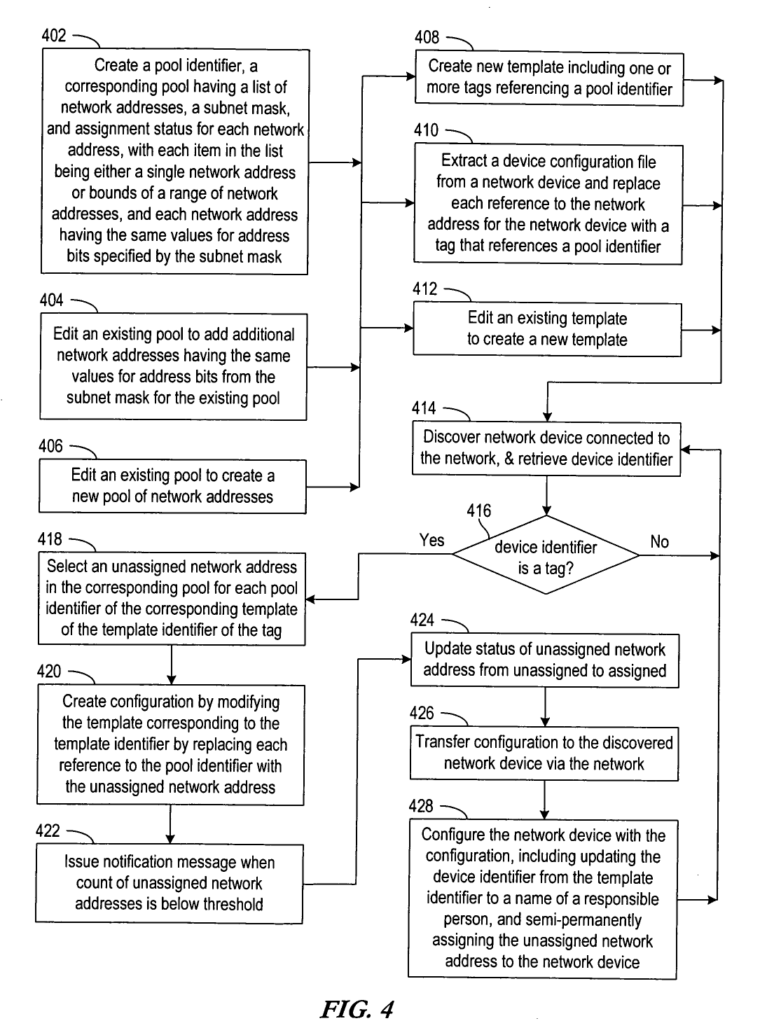

FIG. 4 is a flow diagram of a process for a network manager configuring network devices in accordance with various embodiments of the invention. The network manager may be the ProCurve Manager available from Hewlett-Packard Company.

During steps 402, 404, and 406, a network administrator may create pool identifiers and corresponding pools of network addresses using a network manager. At step 402, a pool identifier is created, and associated with the pool identifier is a subnet mask and a corresponding pool of network addresses with each of these network addresses having the same value for address bits that are specified by the subnet mask. The subnet mask may be used by the network manager for checking each network address in the pool. Each network address in the pool may have an assignment status that usually is initialized to a value of unassigned to indicate the network addresses are available for assignment to a network device. The pool of network addresses may be specified by a list including individual network addresses and the bounds of ranges of network addresses. At step 404, additional network addresses may be added to existing pool. At step 406, an existing pool may be used as a starting point for creating a new pool identifier and corresponding pool of network addresses.

During steps 408, 410, and 412, a network administrator may create template identifiers and corresponding templates using a network manager. At step 408, a new template identifier and corresponding template is created with the corresponding template including one or more tags that reference a pool identifier. In an embodiment of the ProCurve Manager, the tag is similar to a tag of an extensible markup language, for example, <IP_Pool=poolidentifier> with poolidentifier being the text string for the referenced pool identifier. At step 410, a network administrator may direct the network manager to query the current configuration of a particular network device. This particular network device may return a device configuration file that specifies the values of the configurable parameters of the network device. The network manage may generate a template by replacing each occurrence of the network address in the device configuration file with a reference to a specified pool identifier. The network administrator may optionally revise the template according to the purpose of the template. At step 412, an existing template may be used as a starting point for creating a new template identifier and corresponding template.

At step 414, the presence of the network device on the network is discovered by the network manager and the value of the device identifier is retrieved from the network device via the network. Decision 416 checks whether the device identifier has the appropriate format for a tag including a template identifier. Decision 416 may also check whether the template identifier matches a template identifier created during one of steps 408, 410, and 412.

For a device identifier appropriately including a template identifier, a currently unassigned network address is selected at step 418 from each pool that is referenced by a pool identifier in the corresponding template for the template identifier. At step 420, a configuration is created for the discovered network device by replacing each reference to the pool identifier in the template with the selected network address from the pool. At step 422, the network manager may determine a count of the remaining unassigned network addresses in the pool, and if the count is below a threshold limit, the network manager may issue a notification message, such as an automatically generated electronic mail message, to the network administrator. In response, the network administrator may allocate additional network addresses to the pool at step 404. At step 424, the network manager updates the status of the network address selected at step 418 from a status of unassigned to a status of assigned.

At step 426, the configuration generated at step 420 is transferred via the network from the network manager to the discovered network device. At step 428, the network device is configured with the transferred configuration. The configuration of the network device may update the device identifier from the tag including the template identifier to a name of a person or contact that is responsible for the network device. The configuration of the network device may also semi-permanently assign the previously unassigned network address selected at step 418 to the network device.

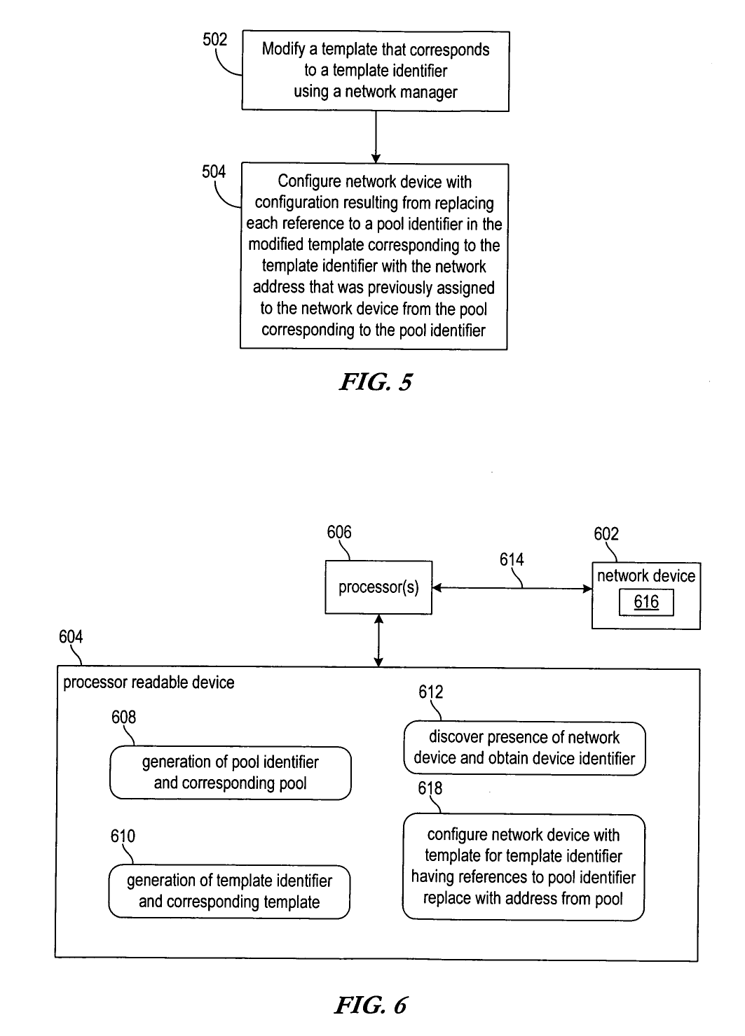

FIG. 5 is a flow diagram of a process for reconfiguring a network device in accordance with various embodiments of the invention. The network device may be previously configured with a configuration that the network administrator wants to modify. During the previous configuring of the network device, the device identifier of the network device may have been set to a tag including the template identifier and a version number and/or a checksum of the previous configuration. For example, the device identifier may be <PCM_Template=templateidentifier, versionnumber> with versionnumber being a text string for the version number. During discovery of the network device or under direction of a network administrator, the network manager may obtain the device identifier, extract the template identifier and the version number, and compare the extracted version number with the current version number from the corresponding template for the template identifier. If the extracted version number and the current version number do not match, the network manager may reconfigure the network device with the current configuration.

At step 502, a network administrator may update a template using a network manager to change the existing configuration of a group of network devices. The updating of the template may include updating a version number associated with template. At step 504, the network manager may configure the network device with a configuration that results from replacing the references to the pool identifier in the modified template with the network address that was previously assigned to the network device. The network manager may bypass assigning a new network address to the network device because the version number extracted from the device identifier is not the null version number provided when the device identifier was initialized. During configuring of the network device with the modified configuration, the device identifier may be updated to include the updated version number along with the template identifier.

FIG. 6 is a block diagram illustrating a program storage medium for configuring a network device 602 in accordance with various embodiments of the invention. A processor-readable device 604 may include instructions for configuring the network device 602, and execution of the instructions by one or more processors 606 may cause the one or more processors 606 to implement a network manager providing various operations for configuring the network device 602. The instructions of software module 608 may create a pool identifier and a corresponding pool of at least one network address. The instructions of software module 610 may create a template identifier and a corresponding template including at least one reference to the pool identifier. The instructions of software module 612 may discover the presence of the network device 602 on the network 614, including obtaining the device identifier 616 that includes the template identifier from the network device 602 via the network 614. The instructions of software module 618 may configure the network device 602 via the network 614 with a configuration that is the corresponding template for the template identifier having each reference to the pool identifier replaced with an unassigned network address of the at least one network address of the corresponding pool for the pool identifier.

What is claimed is:

1. A processor-implemented method for configuring a network device by a network manager, the method comprising:
creating a pool identifier and a corresponding pool of at least one network address using the network manager;
creating a template identifier and a corresponding template including at least one reference to the pool identifier using the network manager;
setting a device identifier of the network device to a first value including the template identifier before coupling the network device to a network;
coupling the network device to the network;
discovering presence of the network device on the network by the network manager, including transferring the device identifier from the network device to the network manager via the network; and
configuring the network device by the network manager via the network with a configuration that is the corresponding template for the template identifier having each reference to the pool identifier replaced with one of the at least one network address of the corresponding pool for the pool identifier.

2. The method of claim 1, further comprising:
modifying the corresponding template using the network manager; and
reconfiguring the network device by the network manager via the network with another configuration that is the corresponding template for the template identifier after the modifying having each reference to the pool identifier replaced with the one of the at least one network address that was semi-permanently assigned to the network device during the configuring.

3. The method of claim 2, wherein the configuring the network device includes setting the device identifier of the network device to a second value that includes the template identifier and indicates the network device is configured with the configuration, and the reconfiguring the network device includes setting the device identifier of the network device to a third value that includes the template identifier and indicates the network device is configured with the another configuration.

4. The method of claim 1, wherein the network device is one of a network switch and a network router.

5. The method of claim 1, wherein the creating the corresponding pool for the pool identifier includes specifying the at least one network address with a list of at least one item, each item specifying one of a network address and bounds of a range of a plurality of network addresses.

6. The method of claim 1, wherein the creating the corresponding pool for the pool identifier includes specifying a subnet mask that identifies a plurality of address bits that each have the same value for each network address in the corresponding pool.

7. The method of claim 1, wherein the creating the pool identifier and the corresponding pool includes creating a plurality of pool identifiers and creating a corresponding pool of at least one network address for each of the plurality of pool identifiers, and the creating the template identifier and the corresponding template includes creating a plurality of template identifiers and creating a corresponding template for each of the plurality of template identifiers, each corresponding template including at least one reference to at least one of the plurality of pool identifiers.

8. The method of claim 1, wherein the creating the corresponding template for the template identifier includes extracting a device configuration file from another network device, and replacing each reference to a network address for the another network device in the device configuration file with the pool identifier.

9. The method of claim 8, further comprising modifying the corresponding template according to a purpose of the corresponding template.

10. The method of claim 1, wherein the creating the corresponding template for the template identifier includes specifying the at least one reference to the pool identifier with a tag.

11. The method of claim 1, wherein the setting the device identifier of the network device to the first value includes specifying the device identifier with a tag.

12. The method of claim 1, wherein the coupling the network device to the network includes assigning a temporary network address to the network device and connecting the network device to a subnet of the network.

13. The method of claim 12, wherein the configuring the network device by the network manager with the configuration includes terminating the assigning the temporary network address to the network device and semi-permanently assigning the one of the at least one network address to the network device.

14. The method of claim 1, wherein the discovering the presence of the network device on the network by the network manager includes discovering the presence of the network device on the network by the network manager in response to the coupling the network device to the network.

15. The method of claim 1, wherein the configuring the network device by the network manager with the configuration includes configuring the network device by the network manager with the configuration in response to the device identifier from the network device appropriately including the template identifier.

16. The method of claim 1, wherein the network device provides the device identifier for a purpose of specifying a person responsible for the network device.

17. The method of claim 1, wherein the configuring the network device by the network manager with the configuration includes updating the device identifier from the first value to a second value that indicates the network device is configured with the configuration.

18. The method of claim 17, wherein the second value is a name of a person responsible for the network device that is included in the corresponding template for the template identifier.

19. The method of claim 1, wherein the configuring the network device by the network manager with the configuration includes semi-permanently assigning the one of the at least one network address to the network device.

20. The method of claim 19, wherein the configuring the network device by the network manager further includes tracking an assignment status for each network address in the corresponding pool for the pool identifier, selecting the one of the at least one network address as one of the at least one network address having the assignment status of unassigned, and updating the assignment status from unassigned to assigned.

21. The method of claim 20, wherein the configuring the network device by the network manager further includes determining a count of the at least one network address having the assignment status of unassigned, and issuing a notification message to a user of the network manager in response to the count being below a threshold.

22. A processor-implemented system for configuring a network device, comprising:
a network device adapted to have a device identifier of the network device be initialized to a value including a template identifier;
a network coupling the network device and a network manager; and
the network manager adapted to create a pool identifier and a corresponding pool of at least one network address, to create a template identifier and a corresponding template including at least one reference to the pool identifier, to discover presence of the network device on the network including obtaining the device identifier from the network device via the network, and, in response to the device identifier from the network device appropriately including the template identifier, to configure the network device via the network with a configuration that is the corresponding template for the template identifier having each reference to the pool identifier replaced with an unassigned network address of the at least one network address of the corresponding pool for the pool identifier.

23. The system of claim 22, wherein the network device is further adapted to have an address of the network device be initialized to a temporary network address, and the network manager is further adapted to reset the address to the unassigned network address and to set the device identifier of the network device to a value that indicates the network device is configured with the configuration.

24. A processor-implemented system for configuring a network device, comprising:
means for creating a pool identifier, a corresponding pool of at least one network address, a template identifier, and a corresponding template including at least one reference to the pool identifier;
means for setting a device identifier of the network device to a value including the template identifier;
means for discovering presence of the network device on a network, including obtaining the device identifier from the network device via the network; and
means for configuring the network device with a configuration that is the corresponding template for the template identifier having each reference to the pool identifier replaced with an unassigned network address of the at least one network address of the corresponding pool for the pool identifier.

25. A program storage medium, comprising:
a processor-readable device configured with instructions for configuring a network device, wherein execution of the instructions by one or more processors causes the one or more processors to perform operations including,
generating a pool identifier and a corresponding pool of at least one network address;
generating a template identifier and a corresponding template including at least one reference to the pool identifier;
discovering presence of the network device on a network, including obtaining a device identifier that includes the template identifier from the network device via the network; and
configuring the network device via the network with a configuration that is the corresponding template for the template identifier having each reference to the pool identifier replaced with an unassigned network address of the at least one network address of the corresponding pool for the pool identifier.
